(19) United States
(12) Patent Application Publication
(10) Pub. No.: US 2026/0135786 A1
(43) Pub. Date: May 14, 2026

(54) METHOD AND APPARATUS FOR SIGNALLING TRAFFIC MONITORING IN COMMUNICATION SYSTEM

(71) Applicant: Samsung Electronics Co., Ltd., Suwon-si, (KR)

(72) Inventors: Deepanshu GAUTAM, Bangalore (IN); Ashok Kumar NAYAK, Bangalore (IN); Ashutosh KAUSHIK, Bangalore (IN); Jamsheed Manja PPALLAN, Bangalore (IN)

(21) Appl. No.: 19/388,545

(22) Filed: Nov. 13, 2025

Related U.S. Application Data
(63) Continuation of application No. PCT/KR2025/095714, filed on Nov. 12, 2025.

(30) Foreign Application Priority Data
Nov. 13, 2024 (IN) 202411087744
Oct. 31, 2025 (IN) 202411087744

(51) Int. Cl. H04L 43/062; H04L 43/0817

(52) U.S. Cl. CPC H04L 43/062; H04L 43/0817

(57) ABSTRACT

A method for signalling traffic monitoring (STM) control by an STM management producer is provided. The method may comprise receiving, from an STM management consumer, a request to create one or more STM control objects; creating the one or more STM control objects, based on receiving the request; receiving, from the STM management consumer, an attribute for enabling the created one or more STM control objects; enabling the one or more STM control objects based on receiving the attribute for enabling the one or more STM control objects; and transmitting a report for signalling messages based on the enabled one or more STM control objects.

### CROSS-REFERENCE TO RELATED APPLICATIONS

This application is a continuation of International Application No. PCT/KR2025/095714 designating the United States, filed on Nov. 12, 2025, in the Korean Intellectual Property Receiving Office and claiming priority to Indian Provisional Patent Application No. 202411087744, filed on Nov. 13, 2024, and Indian Complete patent application No. 202411087744, filed on Oct. 31, 2025, in the Indian Patent Office, the disclosures of each of which are incorporated by reference herein in their entireties.

### BACKGROUND

### Field

The disclosure relates to communication system, for example, but not exclusively to traffic monitoring and management in mobile communication networks.

### Description of Related Art

A Fifth Generation (5G) system comprises of 5G Access Network (AN), 5G Core Network (CN) and UE. The 5G system is expected to be able to provide optimized support for a variety of different communication services, different traffic loads, and different end user communities. For example, communication services using network slicing may include vehicle-to-everything (V2X) services. The 5G system aims to enhance its capability to meet Key Performance Indicators (KPI) that emerging V2X applications require. For these advanced applications, the requirements, such as data rate, reliability, latency, communication range and speed, are made more stringent, 5G seamless Enhanced Mobile Broadband (eMBB). As one of the key technologies to enable network slicing, Fixed Mobile Convergence (FMC) which includes Wireless-to-the-everything (WTTx) and Fibre-to-the-everything (FTTx), is expected to provide native support for network slicing. For optimization and resource efficiency, the 5G system may select the most appropriate 3GPP or non-3GPP access technology for a communication service, potentially allowing multiple access technologies to be used simultaneously for one or more services active on the UE, massive IoT connections. Support for massive Internet of Things (mIoT) brings many new requirements in addition to Mobile Broadband (MBB) enhancements. Communication services with massive IoT connections such as smart households, smart grid, smart agriculture and smart meter may require the support of a large number and high density IoT devices to be efficient and cost effective.

Operators can use one or more network slice instances to provide these communication services, which require similar network characteristics, to different vertical industries. 3GPP TS 28.530 and 28.531 define the management of network slice in 5G networks. It also defines the concept of communication services, which are provided using one or multiple network slices. A Network Slice Instance (NSI) may support multiple Communication Service Instances (CSI). Similarly, a CSI may utilize multiple NSIs.

In the current communication networks, external monitoring systems are often used by mobile network operators (MNOs) to track network activity for analysis and troubleshooting purposes, and subsequently to perform diagnosis and fault analysis of their system. Such monitoring system(s) are under the control of the MNOs, and the monitoring is performed at signalling level. In 5G Core (5GC) networks, signalling traffic between network functions is encrypted using protocols such as mTLS. This encryption prevents/blocks MNOs) from accessing signalling data for operational support systems (OSS), fault analysis, and performance monitoring. Currently, MNOs must request each vendor to send unencrypted copies of signalling messages, resulting in high integration effort and increased operational expenditure (as shown in FIG. 7).

Thus the existing approaches inhibit the MNOs performing troubleshooting for operations and management procedures. In view of the above, there is a need to address one or more of the above mentioned problems.

The information disclosed in this background of the disclosure section is to aid in understanding of the general background and should not be taken as an acknowledgement or any form of suggestion that this information forms the prior art already known to one skilled in the art.

### SUMMARY

Embodiments of the disclosure provide a method and a system for method monitoring signaling traffic in a communication network.

According to an example embodiment, a method for signalling traffic monitoring, STM, control by an STM management producer is provided. The method may comprise receiving, from an STM management consumer, a request to create one or more STM control objects. The method may comprise creating the one or more STM control objects, based on receiving the request. The method may comprise receiving, from the STM management consumer, an attribute for enabling the created one or more STM control objects. The method may comprise enabling the one or more STM control objects based on receiving the attribute for enabling the one or more STM control objects. The method may comprise transmitting a report for signalling messages based on the enabled one or more STM control objects.

The request to create the one or more STM control objects may include an information object class (IOC) including at least one of: an attribute specifying a network function whose signalling traffic is to be monitored; an attribute specifying target network interfaces to be monitored; or an attribute indicating a uniform resource identifier (URI) of an STM consumer that shall receive monitoring signalling message copies.

The IOC may be contained in a managed element or a managed function.

The request to create the one or more STM control objects may include an information object class (IOC) including at least one of: an attribute specifying network interface instances to be monitored; or an attribute specifying service operations to be monitored.

The request to create the one or more STM control objects may be received using createMOI operation or change MOIs operation.

The attribute for enabling the created one or more STM control objects may be received using changeMOI containing only the attribute for enabling the created one or more STM control objects.

According to an embodiment, a signalling traffic monitoring, STM, management producer for STM control is provided. The STM management producer may comprise memory storing instructions; and at least one processor operably coupled to the memory. The instructions, when executed by the at least one processor, may cause the STM management producer to receive, from an STM management consumer, a request to create one or more STM control objects. The instructions, when executed by the at least one processor, may cause the STM management producer to create the one or more STM control objects, based on receiving the request. The instructions, when executed by the at least one processor, may cause the STM management producer to receive, from the STM management consumer, an attribute for enabling the created one or more STM control objects. The instructions, when executed by the at least one processor, may cause the STM management producer to enable the one or more STM control objects based on receiving the attribute for enabling the one or more STM control objects. The instructions, when executed by the at least one processor, may cause the STM management producer to transmit a report for signalling messages based on the enabled one or more STM control objects.

According to an embodiment, a-transitory computer readable storage medium storing instructions is provided. The instructions, when executed by at least one processor of an STM management producer, may cause the STM management producer to receive, from an STM management consumer, a request to create one or more STM control objects. The instructions, when executed by the at least one processor, may cause the STM management producer to create the one or more STM control objects, based on receiving the request. The instructions, when executed by the at least one processor, may cause the STM management producer to receive, from the STM management consumer, an attribute for enabling the created one or more STM control objects. The instructions, when executed by the at least one processor, may cause the STM management producer to enable the one or more STM control objects based on receiving the attribute for enabling the one or more STM control objects. The instructions, when executed by the at least one processor, may cause the STM management producer to transmit a report for signalling messages based on the enabled one or more STM control objects.

The foregoing is illustrative and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example environment of a MNO accessing a core network, according to various embodiments;

FIG. 2 is a block diagram illustrating an example configuration of a Signalling Traffic Monitoring (STM) system, according to various embodiments;

FIG. 3 is a block diagram illustrating an example configuration of a Network Function (NF), according to various embodiments;

FIG. 4 is a diagram illustrating an example of how the STM NRM is incorporated with Generic Provisioning management service as an individual NRM enabling signalling traffic monitoring according to various embodiments;

FIG. 5 is a flowchart illustrating an example method for monitoring signaling traffic in a communication network, according to various embodiments; and

FIG. 6 is a signal flow diagram illustrating example call flow between elements of a STM system, according to various embodiments.

FIG. 7 shows a structure of an exemplary existing network structure.

It should be appreciated by those skilled in the art that any block diagrams herein represent conceptual views of illustrative systems embodying the principles of the present subject matter. Similarly, it will be appreciated that any flowcharts, flow diagrams, state transition diagrams, pseudo code, and the like represent various processes which may be substantially represented in computer-readable medium and executed by a computer or processor, whether or not such computer or processor is explicitly shown.

### DETAILED DESCRIPTION

The present disclosure discloses a method and system for monitoring traffic in Fifth Generation (5G) systems which enables specifying a type of signaling to be monitored. The present disclosure allows a monitoring system to specify signalling traffic requirements including type of signalling to be monitored and sent to the collection entity inside the monitoring system. The collected signalling may be used to enable better and efficient performance and fault management purpose at the 3GPP management system.

An embodiment of the present disclosure introduces an IOC (Information (or Instance) Object Class) using which consumer can provide its requirement pertaining to signaling traffic monitoring. This IOC may be used for controlling the signaling traffic monitoring for the related managed function. In an embodiment, the IOC can be contained in the managed element or directly in the managed function. The IOC may be called Signalling Traffic Monitoring (STM) Ctrl and may contain information dictating the requirements for monitoring targeted signaling messages. In an embodiment, the Information (or Instance) Object Class (IOC) inherits from TOP IOC, as defined in 3GPP TS 28.622, and may include the following attributes illustrated in Table 1 below:

TABLE 1

| Attribute | | isRead- | isWrit- | isIn- | isNoti- | | Attribute |
|---|---|---|---|---|---|---|---|
| name | S | able | able | variant | fyable | Description | Properties |
| Administrative | M | T | T | F | T | This will define the administrative | type: ENUM |
| State | | | | | | state of the monitoring function | multiplicity: 1 |
| | | | | | | deployed as a managed object | isOrdered: N/A |
| | | | | | | instance. The administrative state | isUnique: N/A |
| | | | | | | describes the permission to use or | defaultValue: |
| | | | | | | prohibition against using the object | LOCKED |
| | | | | | | instance. The adminstrative state is | isNullable: False |
| | | | | | | set by the MnS consumer. | |
| | | | | | | The value are “LOCKED” and | |
| | | | | | | “UNLOCKED”. | |
| Managed | M | T | T | F | T | This identifies the related Managed | type: DN |
| Function | | | | | | Function SignallingMonitoringCtrl | multiplicity: 1 |
| identifier | | | | | | IOC. In other words, this defines the | isOrdered: N/A |
| | | | | | | network function for which the | isUnique: N/A |
| | | | | | | monitoring is to be done. This will | defaultValue: None |
| | | | | | | be the DN (Domain Name) of the | isNullable: False |
| | | | | | | instantiated managed function MOI | |
| | | | | | | (Managed Object Instance). | |
| Target | M | T | T | F | T | This defines the information related | type: String |
| interface | | | | | | with target interface supported by | multiplicity: * |
| information | | | | | | the managed function. | isOrdered: False |
| | | | | | | | isUnique: True |
| | | | | | | | defaultValue: None |
| | | | | | | | isNullable: False |
| streamTarget | M | T | T | T | T | It specifies the Uniform Resource | type: Uri |
| | | | | | | Identifier (URI) of the streaming | multiplicity: 1 |
| | | | | | | target where the signalling traffic | isOrdered: N/A |
| | | | | | | shall be sent. The detailed URI | isUnique: N/A |
| | | | | | | structure is defined in clause 4.4 | defaultValue: None |
| | | | | | | of 3GPP TS 32.158. | isNullable: False |
| >Interface | M | T | T | F | T | This identifies the interface for | type: String |
| Identifier | | | | | | which the monitoring is to be | multiplicity: 1 |
| | | | | | | performed. This will be the DN of | isOrdered: N/A |
| | | | | | | MOI instantiated using any endpoint | isUnique: N/A |
| | | | | | | IOC (e.g EP_N2, EP_N3) as defined | defaultValue: None |
| | | | | | | in 3GPP TS 28.541. | isNullable: False |
| >Required | O | T | T | F | T | This defines the exposed services | type: String |
| Services | | | | | | for which the monitored is | multiplicity: * |
| | | | | | | required. | isOrdered: False |
| | | | | | | | isUnique: True |
| | | | | | | | defaultValue: None |
| | | | | | | | isNullable: False |
| >>Service | M | T | T | F | T | This defines exposed service to | type: String |
| Name | | | | | | monitor. This will be Service Name | multiplicity: 1 |
| | | | | | | as specified in clause 5.2 of 3GPP | isOrdered: N/A |
| | | | | | | TS 28.502 | isUnique: N/A |
| | | | | | | | defaultValue: None |
| | | | | | | | isNullable: False |
| >>Service | O | T | T | F | T | This defines the operation of the | type: String |
| Operation | | | | | | service that needs to be monitored. | multiplicity: 1 |
| | | | | | | This will be Service Operations as | isOrdered: N/A |
| | | | | | | specified in clause 5.2 of 3GPP TS | isUnique: N/A |
| | | | | | | 28.502 | defaultValue: None |
| | | | | | | | isNullable: False |
| >>Target | O | T | T | F | T | This defines consumer (another | type: String |
| Consumer | | | | | | managed function) of the service that | multiplicity: 1 |
| | | | | | | needs to be monitored. This will be | isOrdered: N/A |
| | | | | | | Known Consumer(s) as specified in | isUnique: N/A |
| | | | | | | clause 5.2 of 3GPP TS 28.502 | defaultValue: None |
| | | | | | | | isNullable: False |
| >N2 | CM | T | T | F | T | This defines the NGAP signalling | type: String |
| operations | | | | | | that need to be monitored. This will | multiplicity: 1 |
| | | | | | | be present only when the Interface | isOrdered: N/A |
| | | | | | | Identifier is EP_N2. | isUnique: N/A |
| | | | | | | | defaultValue: None |
| | | | | | | | isNullable: False |
| >>Elementary | CM | T | T | F | T | This defines the type of procedure | type: String |
| Procedure | | | | | | that need to be monitored. This will | multiplicity: 1 |
| Type | | | | | | defined as EUM with possible value | isOrdered: N/A |
| | | | | | | as “CLASS 1” and “CLASS 2”. | isUnique: N/A |
| | | | | | | The value CLASS 1 indicates that all | defaultValue: None |
| | | | | | | the procedures defined in Table 8.1- | isNullable: False |
| | | | | | | 1: Class 1 procedures of 3GPP TS | |
| | | | | | | 38.413 will be monitored. | |
| | | | | | | The value CLASS 2 indicates that all | |
| | | | | | | the procedures defined in Table 8.1- | |
| | | | | | | 2: Class 2 procedures of 3GPP TS | |
| | | | | | | 38.413 will be monitored. | |
| >>Elementary | CM | T | T | F | T | This defines the list of procedures | type: String |
| Procedure | | | | | | that need to be monitored. | multiplicity: * |
| | | | | | | Either Elementary Procedure Type or | isOrdered: False |
| | | | | | | Elementary Procedure will be | isUnique: True |
| | | | | | | present | defaultValue: None |
| | | | | | | | isNullable: False |

The semantics of isReadable, isWritable, isInvariant, isNotifyable and attribute properties are as per the definitions in 3GPP TS 32.156.

The present disclosure introduces a new Network Resource Model (NRM) relation of signalling traffic monitoring Ctrl, in accordance with various example embodiments of the present disclosure.

The NRM relation of signalling may have name containment relationships of Signalling Traffic Monitoring Ctrl (STM) IOC. The first block diagram signifies that the Signalling Traffic Monitoring Ctrl is name contained with subnetwork and managed element or managed function as defined in 3GPP TS 28.622. Second block diagram signifies that the Signalling Traffic Monitoring (STM) Ctrl is name contained directly into the Managed Function IOC.

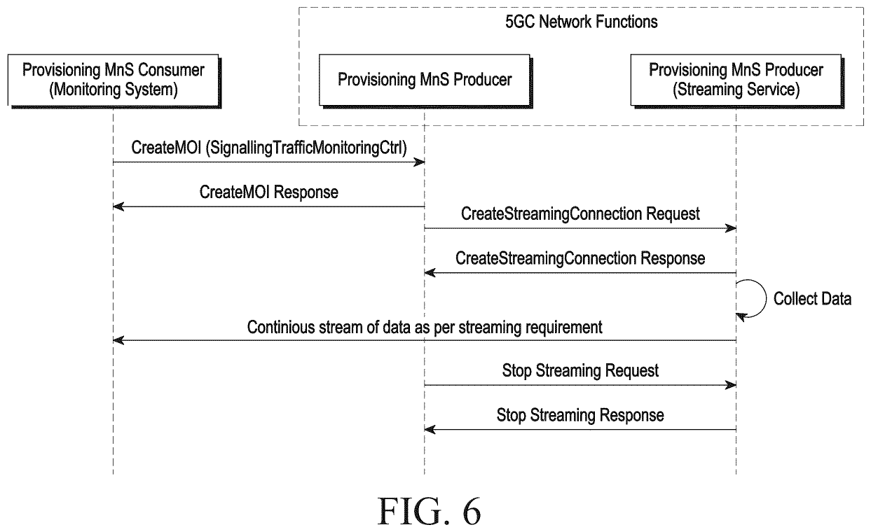

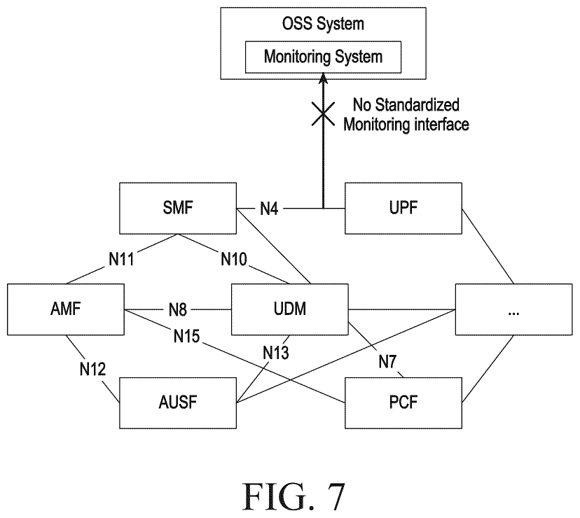

FIG. 6 is a signal flow diagram illustrating an example procedure for Signaling Traffic Monitoring (STM) management according to various embodiments.

As shown, first, a monitoring system, behaving a provisioning MnS Consumer, sends a create Managed Object Instance (MOI) request for Signalling Traffic Monitoring (STM) Ctrl with the information as shown. On receiving the request, a producer acknowledges the receipt and creates a stream data reporting job with the streaming service as defined in 3GPP TS 28.532. The request may contain Uniform Resource Identifier (URI) of the monitoring system that should be used to establish the streaming connection. On receiving the streaming connection request, a streaming service producer acknowledge the receipt. Then, a stream service producer establishes the streaming connection and sends the data in a continuous stream.

At a stipulated time, the provisioning MnS producer may choose to stop the streaming, for that it sends a stop streaming request as per 3GPP TS 28.532. Following the stop streaming request, the streaming service producer acknowledges the request and stops streaming.

Thus, the present disclosure discloses a new Information (or Instance) Object Class (IOC) Signalling Traffic Monitoring (STM) Ctrl and its attributes. This may allow a monitoring system to specify signalling traffic requirements including type of signalling to be monitored and send to the collection entity inside the monitoring system. Hence, the collected signalling may be used to enable better and efficient performance and fault management purpose at the 3GPP management system.

In the present disclosure, the word “exemplary” is used herein to refer, for example, to “serving as an example, instance, or illustration”. Any embodiment or implementation of the present subject matter described herein as “exemplary” is not necessarily to be construed as preferred or advantageous over other embodiments.

While the disclosure is susceptible to various modifications and alternative forms, various example embodiments thereof are shown by way of example in the drawings and will be described in greater detail below. It should be understood, however that it is not intended to limit the disclosure to the particular forms disclosed, but on the contrary, the disclosure is intended to cover all modifications, equivalents, and alternative falling within the scope of the disclosure.

The terms “comprises”, “comprising”, or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a device or system or apparatus proceeded by “comprises . . . a” does not, without more constraints, preclude the existence of other elements or additional elements in the device or system or apparatus.

In the following detailed description, reference is made to the accompanying drawings that form a part hereof, and in which are shown by way of illustration of various example embodiments in which the disclosure may be practiced. It is to be understood that other embodiments may be utilized and that changes may be made without departing from the scope of the present disclosure. The following description is, therefore, not to be taken in a limiting sense.

In the present disclosure STM Data Consumer may refer to a consumer that receives the signalling traffic message copies which are streamed by the STM Data Producer. STM Data Producer may refer to a producer that has the responsibility to send the signalling traffic message copies to the STM Data Consumer. STM Management Producer refers to a producer that supports the STM control NRM fragment.

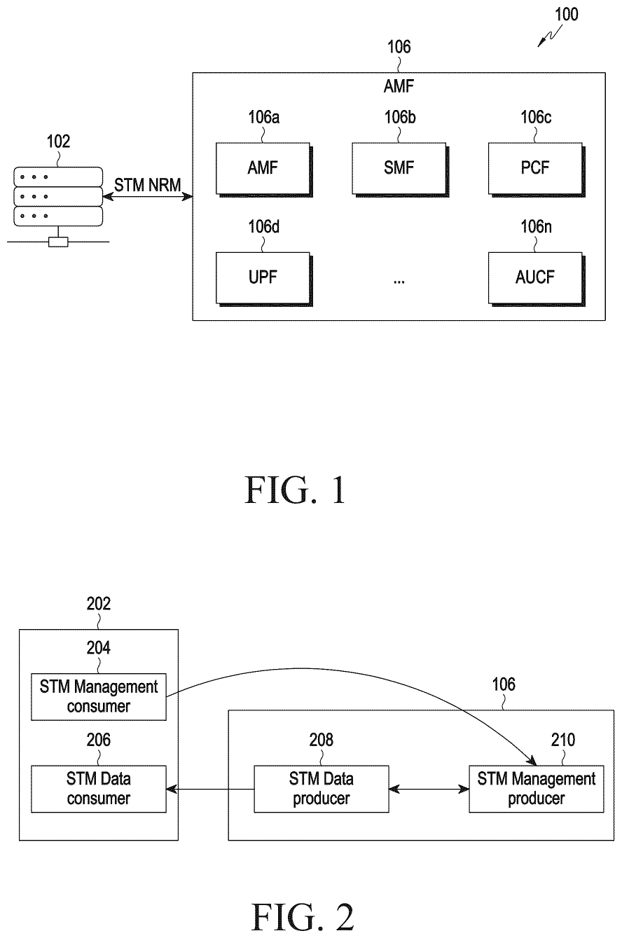

FIG. 1, is a diagram illustrating an example architecture for signaling traffic monitoring in a communication network such as a 5G core network according to various embodiments. The environment 100 within which various embodiments may be implemented includes a 5G core network 104 that comprises of multiple network functions (NFs) 106, such as the Access and Mobility Management Function (AMF) 106a, Session Management Function (SMF) 106b, Policy Control Function (PCF) 106c, User Plane Function (UPF) 106d, Authentication and Authorization Control Function (AUCF) 106n, a User Plane Function (UPF), a Network Exposure Function (NEF), a Network Repository Function (NRF), an Authentication Server Function (ASF), a Unified Data Management Function (UDF), an Application Function (AF) and a Network Slicing Function (NSF) interconnected through different interfaces (N1, N2, etc). The NFs 106 shown in FIG. 1 are only examples and are not limited to the illustrated NFs 106. One skilled will appreciate that other NFs can be included in the core network 104.

FIG. 1 shows an external monitoring system 102 which may include a Mobile Network Operator (MNO) to track network activity for analysis and troubleshooting. The monitoring system 102 may perform diagnosis and fault analysis based on the monitoring. The monitoring system 102 may connect to the core network using the novel interface STM Interface. STM Interface is the combination of STM NRM and generic provisioning management service as defined in 3GPP TS 28.532. The NRM may be in compliance with the NRMs defined in the 3GPP SA5 Service Based Management Architecture (SMBA). The STM NRM serves as an interface that facilitates the collection of signaling traffic data, allowing network operators to effectively monitor and manage the network operations.

The AMF 106a may be responsible for managing user access and mobility within the network. The SMF 106b focuses on session management, ensuring that user sessions are established and maintained correctly. The PCF 106c oversees policy control, managing how data and resources are used within the network. The UPF 106d facilitates the forwarding of user plane data, while the AUCF 106n engages in the authentication and authorization of network processes and users.

In an embodiment, a selection request from the monitoring system is sent to the core network via the STM NRM interface, which allows various NFs 106 to process this data. The respective NF 106 is configured to collect and stream data as per the selection request.

The monitoring system 102 may be located at the operator's Orchestration, Administration and Management (OAM) system or at the external monitoring system.

FIG. 2, is a block diagram illustrating an example configuration of a signaling traffic monitoring (STM) system 202 according to various embodiments. The STM system 202 comprises a STM management consumer 204 and a STM data consumer 206. In various embodiments, the STM system 202 may further comprise a STM management producer 210 and a STM data producer 208. The STM management consumer 204 and the STM data consumer may be referred together as STM consumer and the STM management producer and the STM data producer may be referred together as STM producer.

In an embodiment, the STM management consumer 204 may be located at the operator's OAM or at an external monitoring system. The STM management consumer 204 may receive an input from an operator regarding the data to be collected from the core network 104. In various embodiments, the input may be collected via a user interface (not shown). The STM management consumer 204 may then generate the selection request as per the input received from the operator. The selection request may define one or more signaling traffic monitoring criteria including at least one of, one or more target network functions (NFs) to obtain signaling traffic from, one or more target interface supported by a NF, and a target service operation performed on the interface supported by a NF. The STM management consumer 204 may use the STM Interface for communicating with the STM producer. The STM NRM may define an Information (or Instance) Object Class (IOC) SignallingTrafficMonitoringCtrl. The IOC may be name-contained by SubNetwork, ManagedElement, or ManagedFunction. The STM management consumer 204 may provide the selection request by indicating attribute name such as reportingNFList, networkInterfaceList, stm TargetUri. Further attributes are defined in Table 1. In an embodiment, the IOC may be implemented using RESTful APIs.

In an embodiment, the STM data consumer 206 is configured to receive data stream from the STM data producer 208 corresponding to the selection request. The STM data consumer may then transmit the data stream to an external system or to the OAM system for analytics and troubleshooting. The STM data consumer may or may not be co-located with the STM management consumer. The STM data consumer 206 may receive the data stream over the STM NRM.

In an embodiment, the STM management producer 210 is configured to receive the selection request from the STM management consumer 204 via the IOC SignallingTrafficMonitoringCtrl. Furthermore, the STM management producer 210 configures the STM data producer to collect and stream the data according to the selection request. The STM management producer 210 is configured by the STM management consumer 204 which is authorized, via a secured link. The STM management producer 210 may be configured by an authorized STM management consumer 204 located in OAM system. The STM configuration may be enabled/disabled by the authorized STM management consumer 204 located in the OAM system or located in external monitoring system. When the STM management consumer 204 is located in a different system, the different STM management consumer 204 have different authorization, resulting in a different visibility of the same STM management producer 210.

In an embodiment, the STM data producer 208 reports the data stream collected according to the selection request to the STM data consumer 206. The STM data producer 208 may use a secure tunnel to stream the report to the STM data consumer 206. In an embodiment, the report may be transmitted using one of a User Datagram Protocol (UDP), a Generic Routing Encapsulation (GRE) and a Packet Capture Next Generation (PCAPNG). The STM data producer is configured to collect data from the respective NF based on the signalling traffic monitoring criteria defined in the selection request and generates the stream data comprising the data collected from the respective NF. For example the STM data producer 208 may be configured in the AMF 106a. The STM data producer 208 is then configured to data related to the AMF 106a such as the operations performed by the AMF 106a, the interfaces associated with the AMF 106a and the like.

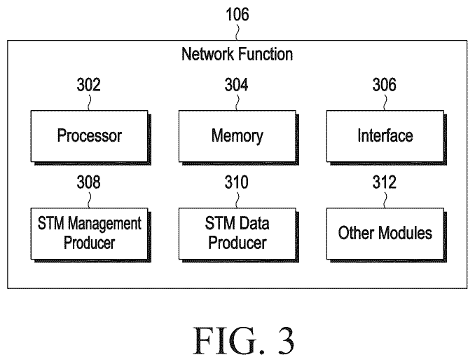

FIG. 3, is a block diagram illustrating an example configuration of a signaling traffic monitoring system according to various embodiments.

The NF 106 comprises a processor (e.g., including processing circuitry) 302, a memory 304 and an Input/Output (I/O) interface (e.g., including circuitry) 306. It may be noted that, in various embodiments, the NF 106 may include more or fewer components than those depicted herein. The various components of the apparatus 106 may be implemented using hardware, software, firmware, or any combinations thereof. The NF 106 may be deployed as a Virtual Network Function (VNF), a Containerized Network Function (CNF) or any other type of NF. Further, the various components of the NF 106 may be operably coupled with each other. More specifically, various components of the NF 106 may be capable of communicating with each other using communication channel media (such as buses, interconnects, etc.).

In an embodiment, the processor 302 may be embodied as a multi-core processor, a single core processor, or a combination of one or more multi-core processors and one or more single core processors. For example, the processor 302 may be embodied as one or more of various processing devices, such as a coprocessor, a microprocessor, a controller, a digital signal processor (DSP), a processing circuitry with or without an accompanying DSP, or various other processing devices including, a microcontroller unit (MCU), a hardware accelerator, a special-purpose computer chip, or the like. The processor 302 may include, but not limited to, the STM management producer 308, the STM data producer 310 and other modules that may perform the functions of the respective NF 106. Thus, the processor 302 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

In an embodiment, the memory 304 is capable of storing machine executable instructions, referred to herein as instruction, a list of operations performed by respective NF, a list of interfaces associated with each NF.

The I/O interface 306 may include various circuitry and/or executable program instructions and is configured to facilitate communication between the apparatus and the electronic device and/or the plurality of applications installed in the electronic device. The I/O interface 306 may obtain selection request via an Application Program Interface (API) from the STM consumer. Further, the I/O interface 306 may be interfaced with other core NFs and other management and orchestration entities.

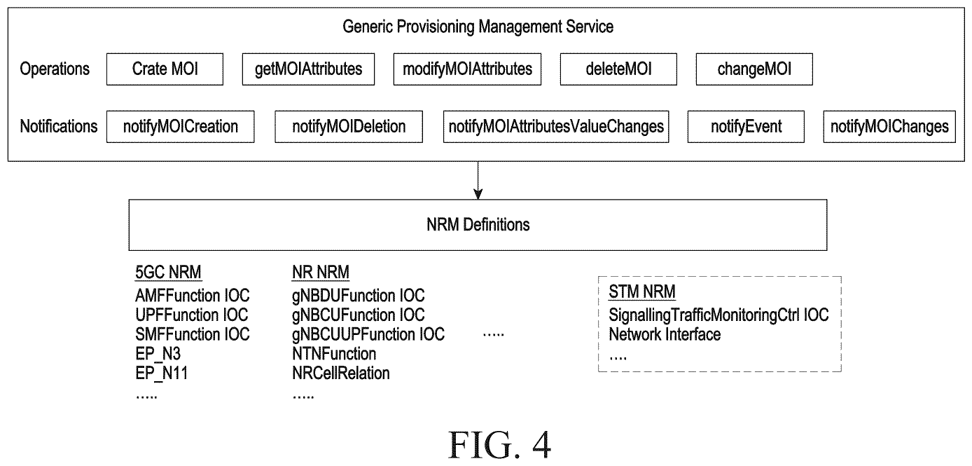

FIG. 4, is a diagram illustrating an example architecture for generic provisioning management service in a 5G core network according to various embodiments. The 3GPP has adopted SMBA where one API (generic provisioning MnS) is defined with its operations and notifications as shown in FIG. 4. For each new functionality only the required resources (NRM) are defined. As can be seen from FIG. 4, the new NRM signallingTraffic MinitoringCtrl IOC is defined to enable efficient and standard way of monitoring the traffic data in the core network 104. The STM consumer may use the operation of the Generic Provisioning MnS to access the defined NRM as resources. For example, to initiate a new instance of the AMF 106a, the STM consumer may send CreateMOI operation for AMFfunction IOC.

In an embodiment, the creation operation may be invoked by STM management consumer 204 to request the STM management producer 208 to create, one or more STM control objects using createMOI or changeMOIs operations as specified in 3GPP TS 28.532. Once the STM control object is created, it may be enabled or disabled by the STM management consumer 204. In various embodiments, STM control objects may be also preconfigured, as per MNO decision.

For instance, parameters may be set to capture signaling traffic specifically related to operations like EB1 Assignment over the N11 interface. This capability addresses the challenges of network operators who traditionally faced difficulties in monitoring traffic due to the complexity and encryption prevalent in 5G networks. With the new NRM, the operations such as the EB1 Assignment over the N11 interface is streamed by the STM data producer 208 to the STM data consumer 206.

In an embodiment, if the STM control object may be enabled by the STM management consumer 204, the STM data producer 208 may report the signalling messages according to the STM control object definition. The enablement operation may be invoked by the STM management consumer 204 using changeMOI containing only the enablement attribute.

In an embodiment, if the STM control object may be disabled by the STM management consumer 204, the reporting of the signalling messages shall be stopped. The disablement operation may be invoked by the STM management consumer 204 using changeMOI containing only the disablement attribute, without STM control object deletion.

In an embodiment, if the STM management consumer 204 is located in the external monitoring system, it may be allowed to perform enabling and disabling operation on the STM control object.

In various embodiments, the deletion operation may be invoked by STM management consumer 204 to request a STM management producer 210 to remove one or more STM control objects using deleteMOI or changeMOIs operations as specified in 3GPP TS 28.532. Upon successful removal of the STM control objects, the STM data producer 210 shall stop reporting any signalling traffic. The STM provision operations shall be secured according to 3GPP TS 33.501.

In an embodiment, STM reporting comprises STM signalling message copies that may be output to streams. The STM data consumer 206 URI may be provided by the STM management consumer 204 to indicate where the STM report shall be streamed to. In case of a failure to report the requested signalling protocol messages, a STM administrative message may be sent to the STM data consumer 206.

In an embodiment, the STM report may be formatted based on operator policy by UDP—GRE—PCAPNG encapsulation or by a generic Type—Length—Value encoding.

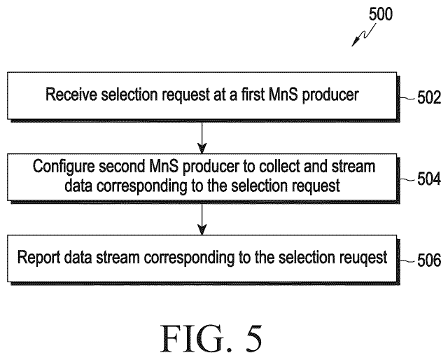

FIG. 5, is a flowchart illustrating an example process 500 of monitoring signaling traffic according to various embodiments. The flowchart outlines the various operations involved in an example method for collecting and reporting targeted signaling data based on specific selection requests from a monitoring system.

At Step 502, the method includes reception of a selection request at the first MnS producer, also referred as the STM management producer 210. This step involves the STM system 202, acting as a consumer, sending a configuration request that specifies the signaling traffic it wishes to monitor. The request may detail parameters such as target Network Functions (NFs), target interfaces, and specific service operations to be observed. For instance, a request may state to monitor signaling operations related to “EBI Assignment” over the “N11” interface between the Access and Mobility Management Function (AMF) and the Session Management Function (SMF).

At step 504 the method includes configuring the second MnS producer, also referred as the STM data producer 208, based on the one or more signaling traffic monitoring criteria in the received selection request. This configuration step is crucial as it enables the system to tailor the data collection process precisely according to the operator's requirements. The second MnS producer is set up to gather and stream the relevant signaling data that meets the criteria outlined in the request. This step may further include setting parameters within the producer that dictate which traffic to collect from the specified NFs. For example, if the request specifies monitoring “EBI Assignment,” the second MnS producer would be configured to target that specific operation on the selected interface.

At step 506, the method includes reporting of the data stream corresponding to the selection request. Once the second MnS producer has collected the data, it proceeds to generate and transmit a continuous stream of the selected signaling traffic back to the monitoring system. This stream may comprise the relevant signaling messages that match the predefined filters set in the former steps. Such a mechanism allows network operators to analyze traffic patterns and perform diagnosis without being overwhelmed by unnecessary data.

In an example scenario, consider a network operator who wishes to specifically monitor all signaling related to the “EBI Assignment” operation occurring on the N11 interface between the AMF and the SMF. The process may initiate with the operator's monitoring system issuing a selection request (process 500) that clearly specifies the “AMF” as the target NF and “N11” as the target interface. Upon configuring the second MnS producer (Step 502), the system is prepared to filter and aggregate only those signaling messages pertinent to “EBI Assignment.” Following configuration, the relevant signaling data is collected and reported (Step 504) in an efficient manner, allowing the operator to conduct relevant analyses and troubleshooting.

The method provides substantial technical advantages. Unlike conventional mechanisms that may send all available signaling data over the network, which generates excessive overload, this method offers the ability to filter and transmit only targeted signaling traffic. This targeted approach significantly enhances operational efficiency by reducing data volume, making it easier for network operators to monitor critical operations while also reducing storage and processing overhead for the monitoring system. The method may also ensure that operators receive actionable insights without needing to manually sift through irrelevant data, thus improving the overall agility and responsiveness of network management activities.

FIG. 6, is a signal flow diagram illustrating an example procedure for a signaling traffic monitoring process according to various embodiments. The diagram illustrates various example operations involved in monitoring signaling traffic, emphasizing each action that the system performs based on specified requirements.

The process may start with the Provisioning MnS Consumer initiating the monitoring procedure by sending a CreateMOI (Signaling Traffic Monitoring Control) request to the Provisioning MnS Producer. This step illustrates the consumer's active role in defining the parameters for which signaling traffic it wishes to monitor. For example, the consumer may specify that it wants to monitor signaling traffic related to “EBI Assignment” operations occurring over the “N11” interface between the Access and Mobility Management Function (AMF) and the Session Management Function (SMF).

The Provisioning MnS Producer responds with a CreateMOI Response, acknowledging the successful receipt of the request and indicating that the environment is prepared for data streaming based on the consumer's specified requirements. This response ensures that the consumer's monitoring criteria have been accepted, and preparations for initiating the streaming process have begun.

The process transitions to the consumer sending a CreateStreamingConnection Request to the Provisioning MnS Producer (Streaming Service). This request is pivotal as it establishes a connection specifically for streaming the relevant signaling data that will be collected per the earlier established configuration.

The CreateStreamingConnection Response, is illustrated, wherein the Provisioning MnS Producer confirms the successful establishment of the streaming connection. This step is crucial for ensuring that the data streaming can commence effectively, providing a direct link between the monitoring system and the data being collected from the network functions.

A Continuous Stream of Data begins, where the system actively collects and streams the specifying signaling data as per the monitoring requirements previously established. This continuous stream of data represents the core functionality of the monitoring system, allowing for real-time insights into signaling activities pertinent to the defined operations.

The data is eventually collected through the streaming service. This operation involves aggregating the streamed signaling messages that conform to the monitoring criteria, successfully filtering out any unrelated traffic. The importance of this operation extends to allowing operators to focus on actionable insights rather than sifting through excessive data. When the monitoring task is complete or needs to be paused, a further step involves sending a Stop Streaming Request. This request initiates the process of terminating the data stream, effectively notifying the system to cease data collection once the required monitoring period has elapsed.

The process may conclude with a Stop Streaming Response, confirming that the data streaming has been successfully terminated. This response solidifies the end of this monitoring operation, ensuring that all captured data is finalized and can be further analyzed without any ongoing data influx.

Throughout this procedure, the system exhibits advantages by enabling targeted monitoring of signaling traffic. This solution ensures that networks can effectively manage and monitor signaling traffic with high precision, scalability, and reduced overload. Unlike conventional methodologies where there was not standard way for providing the traffic data, this method allows for a focused approach that meets specific operational criteria, significantly enhancing the efficiency of network management. The granularity of monitoring targets, coupled with the ability to stream necessary operations continuously, provides the necessary solution to the increasingly complex challenges posed by encrypted signaling and diverse network functions in 5G architectures.

The described operations may be implemented as a method, system or article of manufacture using standard programming and/or engineering techniques to produce software, firmware, hardware, or any combination thereof. The described operations may be implemented as code maintained in a “non-transitory computer readable medium”, where a processor may read and execute the code from the computer readable medium. The processor may include, for example, and without limitation (as described in detail above) at least one of a microprocessor and a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMS, PROMs, RAMS, DRAMs, SRAMs, Flash Memory, firmware, programmable logic, etc.), etc. Further, non-transitory computer-readable media may include all computer-readable media and does not include a signal. The code implementing the described operations may further be implemented in hardware logic (e.g., an integrated circuit chip, Programmable Gate Array (PGA), Application Specific Integrated Circuit (ASIC), etc.).

The illustrated steps describe various example embodiments, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items or meant to be limited to only the listed item or items. It must also be noted that as used herein, the singular forms “a,” “an,” and “the” include plural references unless the context clearly dictates otherwise.

Furthermore, one or more computer-readable storage media may be utilized in implementing various embodiments consistent with the present disclosure. A computer readable storage medium refers to any type of physical memory on which information or data readable by a processor may be stored. Thus, a computer readable storage medium may store instructions for execution by one or more processors, including instructions for causing the processor(s) to perform steps or stages consistent with the various embodiments described herein. The term “computer readable medium” should be understood to include tangible items and exclude carrier waves and transient signals, e.g., are non-transitory. Examples include random access memory (RAM), read-only memory (ROM), volatile memory, non-volatile memory, hard drives, CD ROMs, DVDs, flash drives, disks, and any other known physical storage media.

The language used in the disclosure has been principally selected for readability and instructional purposes, and it may not have been selected to delineate or circumscribe the disclosed subject matter. Accordingly, the disclosure is intended to be illustrative, but not limiting, of the scope of the disclosure.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

What is claimed is:

1. A method for signalling traffic monitoring (STM) control by an STM management producer, the method comprising:
receiving, from an STM management consumer, a request to create one or more STM control objects;
creating the one or more STM control objects, based on receiving the request;
receiving, from the STM management consumer, an attribute for enabling the created one or more STM control objects;
enabling the one or more STM control objects based on receiving the attribute for enabling the one or more STM control objects; and
transmitting a report for signalling messages based on the enabled one or more STM control objects.

2. The method of claim 1, wherein the request to create the one or more STM control objects includes an information object class (IOC) including at least one of:
an attribute specifying a network function whose signalling traffic is to be monitored;
an attribute specifying target network interfaces to be monitored; or
an attribute indicating a uniform resource identifier (URI) of an STM consumer that shall receive monitored signalling message copies.

3. The method of claim 2, wherein the IOC is contained in a managed element or a managed function.

4. The method of claim 1, wherein the request to create the one or more STM control objects includes an information object class (IOC) including at least one of:
an attribute specifying network interface instances to be monitored; or
an attribute specifying service operations to be monitored.

5. The method of claim 1, wherein the request to create the one or more STM control objects is received using createMOI operation or change MOIs operation.

6. The method of claim 1, wherein the attribute for enabling the created one or more STM control objects is received using changeMOI containing only the attribute for enabling the created one or more STM control objects.

7. A signalling traffic monitoring (STM) management producer for STM control, the STM management producer comprising:
memory storing instructions; and
at least one processor operably coupled to the memory, wherein the instructions, when executed by the at least one processor individually or collectively, cause the STM management producer to:
receive, from an STM management consumer, a request to create one or more STM control objects,
create the one or more STM control objects, based on receiving the request,
receive, from the STM management consumer, an attribute for enabling the created one or more STM control objects,
enable the one or more STM control objects based on receiving the attribute for enabling the one or more STM control objects, and
transmit a report for signalling messages based on the enabled one or more STM control objects.

8. The STM management producer of claim 7, wherein the request to create the one or more STM control objects includes an information object class (IOC) including at least one of:
an attribute specifying a network function whose signalling traffic is to be monitored;
an attribute specifying target network interfaces to be monitored; or
an attribute indicating a uniform resource identifier (URI) of an STM consumer that shall receive monitored signalling message copies.

9. The STM management producer of claim 8, wherein the IOC is contained in a managed element or a managed function.

10. The STM management producer of claim 7, wherein the request to create the one or more STM control objects includes an information object class (IOC) including at least one of:
an attribute specifying network interface instances to be monitored; or
an attribute specifying service operations to be monitored.

11. The STM management producer of claim 7, wherein the request to create the one or more STM control objects is received using createMOI operation or change MOIs operation.

12. The STM management producer of claim 7, wherein the attribute for enabling the created one or more STM control objects is received using changeMOI containing only the attribute for enabling the created one or more STM control objects.

13. A non-transitory computer readable storage medium storing instructions which, when executed by at least one processor of a signalling traffic monitoring (STM) management producer (210), cause the STM management producer to perform operations comprising:
receiving, from an STM management consumer, a request to create one or more STM control objects;
creating the one or more STM control objects, based on receiving the request;
receiving, from the STM management consumer, an attribute for enabling the created one or more STM control objects;
enabling the one or more STM control objects based on receiving the attribute for enabling the one or more STM control objects; and
transmitting a report for signalling messages based on the enabled one or more STM control objects.

14. The non-transitory computer readable storage medium of claim 13, wherein the request to create the one or more STM control objects includes an information object class (IOC) including at least one of:
an attribute specifying a network function whose signalling traffic is to be monitored;
an attribute specifying target network interfaces to be monitored; or
an attribute indicating a uniform resource identifier (URI) of an STM consumer that shall receive monitored signalling message copies.

15. The non-transitory computer readable storage medium of claim 14, wherein the IOC is contained in a managed element or a managed function.

16. The non-transitory computer readable storage medium of claim 13, wherein the request to create the one or more STM control objects includes an information object class (IOC) including at least one of:
an attribute specifying network interface instances to be monitored; or
an attribute specifying service operations to be monitored.

17. The non-transitory computer readable storage medium of claim 13, wherein the request to create the one or more STM control objects is received using createMOI operation or change MOIs operation.

18. The non-transitory computer readable storage medium of claim 13, wherein the attribute for enabling the created one or more STM control objects is received using changeMOI containing only the attribute for enabling the created one or more STM control objects.
